(19) United States
(12) Patent Application Publication
(10) Pub. No.: US 2025/0391362 A1
(43) Pub. Date: Dec. 25, 2025

(54) PIXEL, DISPLAY DEVICE AND ELECTRONIC DEVICE HAVING THE SAME

(71) Applicant: Samsung Display Co., Ltd., Yongin-si (KR)

(72) Inventors: Min Kyu WOO, Yongin-si (KR); Jang Mi KANG, Yongin-si (KR); Byung Chang YU, Yongin-si (KR); Geun Ho LEE, Yongin-si (KR)

(21) Appl. No.: 19/210,772

(22) Filed: May 16, 2025

(30) Foreign Application Priority Data
Jun. 19, 2024 (KR) 10-2024-0079580
Nov. 6, 2024 (KR) 10-2024-0156481

(51) Int. Cl. G09G 3/3233; G09G 3/32

(52) U.S. Cl. CPC G09G 3/3233; G09G 3/32; G09G 2300/043; G09G 2300/0819; G09G 2310/08; G09G 2320/0242; G09G 2330/021

(57) ABSTRACT

A pixel includes a second transistor having a control electrode connected to a first node, a first electrode for receiving a first power voltage, and a second electrode connected to a second node, a first transistor having a gate electrode connected to the second node, a first electrode for receiving the first power voltage, and a second electrode connected to a third node, and a light-emitting element configured to be supplied with a driving current from the first transistor, wherein a turn-on time point of the second transistor is determined by a data voltage, and wherein the driving current supplied to the light-emitting element is configured to be interrupted as the second transistor is turned on.

### CROSS-REFERENCE TO RELATED APPLICATION

The present application claims priority to, and the benefit of, Korean Patent Application Number 10-2024-0079580 filed on Jun. 19, 2024, and Korean Patent Application Number 10-2024-0156481 filed on Nov. 6, 2024, in the Korean Intellectual Property Office, the entire disclosures of which are incorporated herein by reference.

### BACKGROUND

### 1. Field

Various embodiments of the disclosure relate to a pixel, a display device, and an electronic device having the same.

### 2. Description of Related Art

With the development of information technology, the importance of a display device, which is a connection medium between a user and information, has been emphasized. Owing to the importance of display devices, the use of various kinds of display devices, such as a liquid crystal display device and an organic light-emitting display device, has increased.

### SUMMARY

Various embodiments of the disclosure are directed to a pixel, a display device, and an electric device including the same, which can reduce a color shift phenomenon of a light-emitting element.

According to one or more embodiments of the disclosure, a pixel includes a second transistor having a control electrode connected to a first node, a first electrode for receiving a first power voltage, and a second electrode connected to a second node, a first transistor having a gate electrode connected to the second node, a first electrode for receiving the first power voltage, and a second electrode connected to a third node, and a light-emitting element configured to be supplied with a driving current from the first transistor, wherein a turn-on time point of the second transistor is determined by a data voltage, and wherein the driving current supplied to the light-emitting element is configured to be interrupted as the second transistor is turned on.

The pixel may further include a third transistor having a control electrode connected to a first scan line, a first electrode connected to the first node, and a second electrode connected to a data line for supplying the data voltage, and a first capacitor having a first electrode connected to a third scan line, and a second electrode connected to the first node, wherein the data voltage is configured to be written to the first node by the first capacitor as the third transistor is turned on.

The third transistor may be configured to be turned off during an emission period, wherein a duty control signal decreasing over time during the emission period is configured to be supplied from the third scan line, and wherein a voltage of the first node is configured to decrease over time by the first capacitor in response to the decreasing duty control signal.

The pixel may further include a current source for supplying a constant current, a second capacitor having a first electrode for receiving the first power voltage, and a second electrode connected to the second node, a fourth transistor having a control electrode connected to a second scan line, a first electrode connected to the second node, and a second electrode connected to the third node, and a fifth transistor having a control electrode connected to the first scan line, a first electrode connected to the third node, and a second electrode connected to the current source.

The fourth transistor and the fifth transistor may be configured to be turned on, and the gate electrode and the second electrode of the first transistor may be configured to be electrically connected to each other, during a first period in a non-emission period.

The constant current may be configured to be supplied to a drain of the first transistor, wherein a voltage at which a threshold voltage of the first transistor is compensated is configured to be written to the second node by the second capacitor.

The fourth transistor and the fifth transistor may be configured to be turned off during an emission period.

The pixel may further include a sixth transistor having a control electrode connected to an emission control line, a first electrode connected to the third node, and a second electrode connected to an anode electrode of the light-emitting element.

The sixth transistor may be configured to be turned off during a non-emission period, and may be configured to be turned on during an emission period.

The first transistor may be configured to be turned off at the turn-on time point of the second transistor during an emission period, wherein the driving current to the light-emitting element is configured to be interrupted as the first transistor is turned off.

According to one or more embodiments of the disclosure, a display device includes a display panel including pixels, a scan driver connected to the display panel through scan lines, a data driver connected to the display panel through data lines, and a timing controller for receiving image data, and for controlling driving of the scan driver and the data driver to display an image corresponding to the image data, wherein the pixels include a second transistor having a control electrode connected to a first node, a first electrode for receiving a first power voltage, and a second electrode connected to a second node, a first transistor having a gate electrode connected to the second node, a first electrode for receiving the first power voltage, and a second electrode connected to a third node, and a light-emitting element configured to be supplied with a driving current from the first transistor, wherein a turn-on time point of the second transistor is configured to be determined by a data voltage supplied through a data line among the data lines, and wherein the driving current to the light-emitting element is configured to be interrupted as the second transistor is turned on.

The scan lines may include a first scan line, a second scan line, and a third scan line, wherein the pixels further include a third transistor having a control electrode connected to the first scan line, a first electrode connected to the first node, and a second electrode connected to the data line, and a first capacitor having a first electrode connected to the third scan line, and a second electrode connected to the first node, wherein the data voltage is configured to be written to the first node by the first capacitor as the third transistor is turned on.

The third transistor may be configured to be turned off during an emission period, wherein a duty control signal decreasing over time during the emission period is configured to be supplied from the third scan line, and wherein a voltage of the first node is configured to decrease over time by the first capacitor in response to the decreasing duty control signal.

The pixels may further include a current source for supplying a constant current, a second capacitor having a first electrode for receiving the first power voltage, and a second electrode connected to the second node, a fourth transistor having a control electrode connected to the second scan line, a first electrode connected to the second node, and a second electrode connected to the third node, and a fifth transistor having a control electrode connected to the first scan line, a first electrode connected to the third node, and a second electrode connected to the current source.

The fourth transistor and the fifth transistor may be configured to be turned on, and the gate electrode and the second electrode of the first transistor may be configured to be electrically connected to each other, during a first period in a non-emission period.

The constant current may be configured to be supplied to a drain of the first transistor, wherein a voltage at which a threshold voltage of the first transistor is compensated is configured to be written to the second node by the second capacitor.

The fourth transistor and the fifth transistor may be configured to be turned off during an emission period.

The pixels may further include a sixth transistor having a control electrode connected to an emission control line, a first electrode connected to the third node, and a second electrode connected to an anode electrode of the light-emitting element.

The sixth transistor may be turned off during a non-emission period and the sixth transistor is turned on during an emission period.

According to one or more embodiments of the disclosure, an electronic device includes a processor for providing input image data, and a display device for displaying an image based on the input image data, wherein the display device includes a display panel including pixels, a scan driver connected to the display panel through scan lines, a data driver connected to the display panel through data lines, and a timing controller for receiving image data and for controlling driving of the scan driver and the data driver to display an image corresponding to the image data, wherein the pixels include a second transistor having a control electrode connected to a first node, a first electrode for receiving a first power voltage, and a second electrode connected to a second node, a first transistor having a gate electrode connected to the second node, a first electrode for receiving the first power voltage, and a second electrode connected to a third node, and a light-emitting element supplied with a driving current from the first transistor, wherein a turn-on time point of the second transistor is determined by a data voltage supplied through a data line among the data lines, and wherein the driving current to the light-emitting element is configured to be interrupted as the second transistor is turned on.

Aspects of embodiments of the disclosure are not limited to the above-described aspects, and other aspects that are not described will be clearly understood by those skilled in the art from the following description.

### BRIEF DESCRIPTION OF THE DRAWINGS

FIG. 1 is a block diagram illustrating a display device according to one or more embodiments of the disclosure.

FIG. 2 is a schematic diagram of an equivalent circuit of a pixel illustrated in FIG. 1.

FIG. 3 is a timing diagram illustrating an example of an operation of the pixel illustrated in FIG. 2.

FIG. 4 is a block diagram illustrating a display device according to one or more other embodiments of the disclosure.

FIG. 5 is a schematic diagram of an equivalent circuit of a pixel illustrated in FIG. 4.

FIG. 6 is a timing diagram illustrating an example of an operation of the pixel illustrated in FIG. 5.

FIG. 7 is an equivalent circuit diagram illustrating the operation of the pixel illustrated in FIG. 5 during a period between t10 and t11 shown in FIG. 6.

FIG. 8 is an equivalent circuit diagram illustrating the operation of the pixel illustrated in FIG. 5 during a period between t11 and t12 shown in FIG. 6.

FIG. 9 is an equivalent circuit diagram illustrating the operation of the pixel illustrated in FIG. 5 during a period between t12 and t13 shown in FIG. 6.

FIG. 10 is a timing diagram illustrating changes in a voltage and a driving current of a first node during an emission period.

FIG. 11 is a block diagram illustrating an electronic device according to one or more other embodiments of the disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

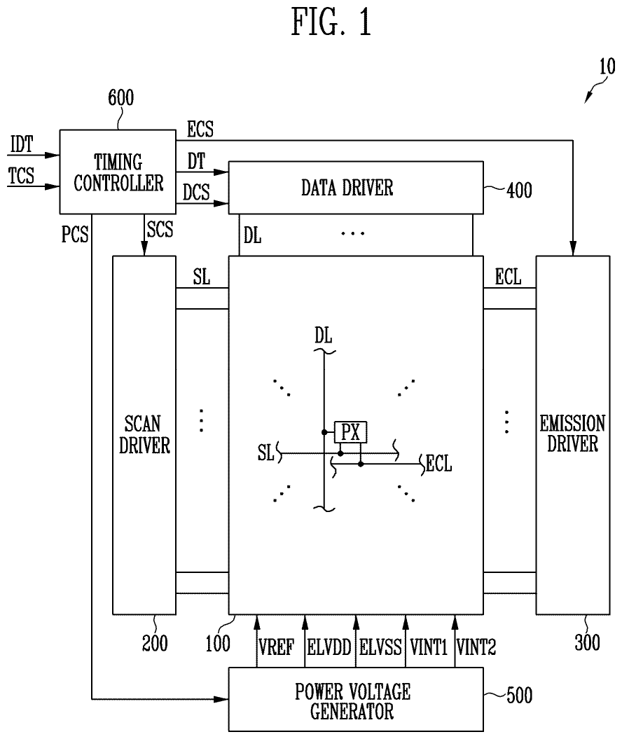

FIG. 1 is a block diagram illustrating a display device 10 according to one or more embodiments of the disclosure.

Referring to FIG. 1, the display device 10 may include a display panel 100, a scan driver 200, an emission driver 300, a data driver 400, a power voltage generator 500, and a timing controller 600. The display device 10 may be, but is not limited to, an organic light-emitting display device or a quantum dot light-emitting display device.

The display panel 100 displays an image. The display panel 100 may include a plurality of pixels PX for displaying an image, and may display an image corresponding to input image data IDT by the plurality of pixels PX.

The plurality of pixels PX may be electrically connected to respective scan lines SL, respective emission control lines ECL, and respective data lines DL. For example, each pixel PX may be electrically connected to the scan line SL and the emission control line ECL located on a corresponding horizontal line, and the data line DL located on a corresponding vertical line.

Although FIG. 1 illustrates that each pixel PX is connected to one scan line SL and one emission control line ECL, embodiments are not limited thereto. For example, two or more scan lines SL, to which different scan signals are applied, may be located on each horizontal line, and each pixel PX may be electrically connected to the two or more scan lines SL. In addition, two or more emission control lines ECL to which different emission control signals are applied may be located on each horizontal line, and each pixel PX may be electrically connected to the two or more emission control lines ECL.

The plurality of pixels PX may be supplied with respective driving signals, and may emit light with luminance corresponding to the driving signals. In one or more embodiments, the driving signals may include respective scan signals supplied to the plurality of pixels PX through respective scan lines SL, respective emission control signals EM supplied to the plurality of pixels PX through respective emission control lines ECL, and respective data signals supplied to the plurality of pixels PX through respective data lines DL.

The plurality of pixels PX may be supplied with driving voltages from the power voltage generator 500. In one or more embodiments, the driving voltages may include a first power voltage ELVDD (for example, a high-potential pixel voltage) and a second power voltage ELVSS (for example, a low-potential pixel voltage), and may include at least one of a reference voltage VREF, a first initialization voltage VINT1, or a second initialization voltage VINT2.

Signal lines and power lines connected to the plurality of pixels PX, and driving signals and driving voltages supplied from the signal lines and the power lines are not limited to the above. Signal lines and/or power lines connected to the plurality of pixels PX, driving signals and/or driving voltages may be variously changed according to a circuit structure and/or a driving method of the plurality of pixels PX.

The scan driver 200 may receive scan-driving signals SCS from the timing controller 600. The scan-driving signals SCS may include sampling signals and/or timing signals suitable for driving the scan driver 200. The scan driver 200 may supply respective scan signals to the scan lines SL based on the scan-driving signals SCS. In one or more embodiments, the scan signals may include a first initialization signal GI, a second initialization signal GB, and a write signal GW.

Each scan signal may have a gate-on voltage capable of turning on a transistor to which the scan signal is supplied. For example, a low-level scan signal may be supplied to a P-type transistor, and a high-level scan signal may be supplied to an N-type transistor. Accordingly, the transistor receiving each scan signal may be turned on in response to the scan signal.

The emission driver 300 may receive emission-driving signals ECS from the timing controller 600. The emission-driving signals ECS may include sampling signals and/or timing signals suitable for driving the emission driver 300. In one or more embodiments, the emission driver 300 may supply the emission control signals EM to the emission control lines ECL based on the emission-driving signals ECS.

Each of the emission control signals EM may have a gate-off voltage capable of turning off a transistor to which the emission control signals EM are supplied. For example, a high-level emission control signal may be supplied to a P-type transistor and a low-level emission control signal may be supplied to an N-type transistor. Accordingly, the transistor receiving each emission control signal may be turned off in response to the emission control signal to maintain an off state during a period in which the emission control signal is supplied.

Although FIG. 1 illustrates one or more embodiments in which the scan driver 200 and the emission driver 300 are provided as separate components, the embodiments are not limited thereto. For example, the scan driver 200 and the emission driver 300 may be integrated into one driving circuit, one module, or the like.

The data driver 400 may receive data-driving signals DCS and image data DT from the timing controller 600. The data-driving signals DCS may include sampling signals and/or timing signals suitable for driving the data driver 400. The data driver 400 may supply respective data signals to the data lines DL based on the data-driving signals DCS and the image data DT. For example, the data driver 400 may generate data signals having analog data voltages corresponding to respective grayscale values included in the image data DT supplied as digital data, and output the data signals to the respective data lines DL. The data signals output to the data lines DL may be supplied to each pixel PX.

The power voltage generator 500 may receive power driving signals PCS from the timing controller 600. The power voltage generator 500 may generate driving voltages of the plurality of pixels PX based on the power driving signals PCS, and supply the driving voltages to the display panel 100 through respective power lines. In one or more embodiments, the power voltage generator 500 may be or may include a power management integrated circuit (PMIC).

In one or more embodiments, the power voltage generator 500 may generate and supply the first power voltage ELVDD, the second power voltage ELVSS, the reference voltage VREF, the first initialization voltage VINT1, and the second initialization voltage VINT2 to the display panel 100. Accordingly, the first power voltage ELVDD, the second power voltage ELVSS, the reference voltage VREF, the first initialization voltage VINT1, and the second initialization voltage VINT2 may be supplied to each of the pixels PX.

The timing controller 600 may receive the input image data IDT and timing control signals TCS from a host system, for example, an application processor (AP), through an interface. The timing control signals TCS may include synchronization signals, such as a vertical synchronization signal and a horizontal synchronization signal, a data enable signal, a clock signal, and the like.

The timing controller 600 may generate the scan-driving signals SCS, the emission-driving signals ECS, the data-driving signals DCS, and the power driving signals PCS based on the timing control signals TCS. The scan-driving signals SCS, the emission-driving signals ECS, the data-driving signals DCS, and the power driving signals PCS may be supplied to the scan driver 200, the emission driver 300, the data driver 400, and the power voltage generator 500, respectively.

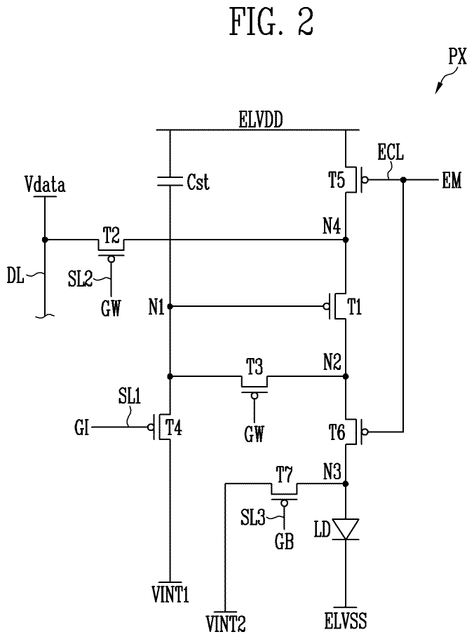

FIG. 2 is a schematic diagram of an equivalent circuit of the pixel PX illustrated in FIG. 1.

Referring to FIG. 2, the pixel PX according to one or more embodiments of the disclosure may be connected to signal lines provided on a corresponding horizontal line and a corresponding vertical line. For example, the pixel PX may be connected to at least one scan line SL and at least one emission control line ECL located on the corresponding horizontal line and the data line DL located on the corresponding vertical line. For example, the pixel PX may be connected to a first scan line SL1, a second scan line SL2, a third scan line SL3, a fourth scan line SL4, a first emission control line ECL1, and a second emission control line ECL2 of the corresponding horizontal line, and the data line DL of the corresponding vertical line.

The pixel PX may include first to seventh transistors T1 to T7, a storage capacitor Cst, and a light-emitting element LD. The pixel PX may be driven by the driving signals and the driving voltages. The driving signals may include the write signal GW and a data signal (for example, a data voltage Vdata). In one or more embodiments, the driving signals may further include the first initialization signal GI, the second initialization signal GB, and the emission control signal EM. The driving voltages may include the first power voltage ELVDD and the second power voltage ELVSS. In one or more embodiments, the driving voltages may include the first initialization voltage VINT1 and/or the second initialization voltage VINT2.

The first transistor T1 (a driving transistor) includes a control electrode connected to a first node N1, a first electrode connected to a fourth node N4, and a second electrode connected to a second node N2. The second transistor T2 includes a control electrode for receiving the write signal GW, a first electrode for receiving the data voltage Vdata, and a second electrode connected to the fourth node N4. The third transistor T3 includes a control electrode for receiving the write signal GW, a first electrode connected to the second node N2, and a second electrode connected to the first node N1. The fourth transistor T4 includes a control electrode for receiving the first initialization signal GI, a first electrode for receiving the first initialization voltage VINT1, and a second electrode connected to the first node N1. The fifth transistor T5 includes a control electrode for receiving the emission control signal EM, a first electrode for receiving the first power voltage ELVDD (for example, a high power voltage), and a second electrode connected to the fourth node N4. The sixth transistor T6 includes a control electrode for receiving the emission control signal EM, a first electrode connected to the second node N2, and a second electrode connected to a third node N3. The seventh transistor T7 includes a control electrode for receiving the second initialization signal GB, a first electrode for receiving the second initialization voltage VINT2 (an anode initialization voltage), and a second electrode connected to the third node N3.

The storage capacitor Cst includes a first electrode for receiving the first power voltage ELVDD, and a second electrode connected to the first node N1. The light-emitting element LD includes a first electrode (an anode electrode) connected to the third node N3, and a second electrode (a cathode electrode) receiving the second power voltage ELVSS (for example, a low power voltage). The data voltage Vdata may be transmitted through the data line DL, and the emission control signal EM may be transmitted through the emission control line ECL.

The first to seventh transistors T1, T2, T3, T4, T5, T6, and T7 may be implemented as p-channel metal oxide semiconductor (PMOS) transistors. In one or more embodiments where the first to seventh transistors T1 to T7 are implemented as PMOS transistors, a low voltage level may be an activation level and a high voltage level may be a deactivation level. For example, when a signal applied to a control electrode of a PMOS transistor has a low voltage level, the PMOS transistor may be turned on. For example, when a signal applied to the control electrode of the PMOS transistor has a high voltage level, the PMOS transistor may be turned off.

However, the disclosure is not limited thereto. For example, the first to seventh transistors T1, T2, T3, T4, T5, T6, and T7 may be implemented as n-channel metal oxide semiconductor (NMOS) transistors. In one or more embodiments where the first to seventh transistors T1 to T7 are implemented as NMOS transistors, a low voltage level may be a deactivation level and a high voltage level may be an activation level. For example, when a signal applied to a control electrode of an NMOS transistor has a low voltage level, the NMOS transistor may be turned off. For example, when a signal applied to the control electrode of the NMOS transistor has a high voltage level, the NMOS transistor may be turned on. The activation level and the deactivation level may be determined according to a type of transistor.

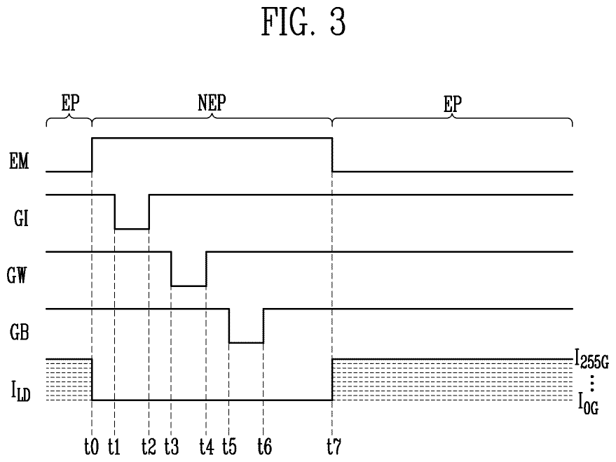

FIG. 3 is a timing diagram illustrating an example of an operation of the pixel PX illustrated in FIG. 2. Hereinafter, the operation of the pixel PX will be described with reference to FIGS. 2 and 3 together.

Referring to FIG. 3, an operation period of a pixel may be divided into an emission period EP and a non-emission period NEP depending on whether the emission control signal EM is activated. In the emission period EP, the first initialization signal GI, the write signal GW, and the second initialization signal GB may have a deactivation level. In addition, the emission control signal EM may have an activation level in the emission period EP. First, the operation of the pixel in the non-emission period NEP will be described.

The non-emission period NEP begins when the emission control signal EM changes to the deactivation level at time to. During the subsequent period between t1 and t2, an initialization operation of the storage capacitor Cst is performed. During the period between t1 and t2, the first initialization signal GI has an activation level, and the fourth transistor T4 may be turned on. Accordingly, the first initialization voltage VINT1 may be applied to the first node N1. A voltage of the control electrode (the storage capacitor Cst) of the first transistor T1 may be initialized.

Thereafter, threshold voltage compensation and data write operations of the first transistor T1 are performed during the periods between t3 and t4. For example, during the period between t3 and t4, the write signal GW has an activation level, and the third transistor T3 may be turned on. Accordingly, the first transistor T1 may be diode-connected. In addition, the second transistor T2 and the third transistor T3 may be turned on during the period between t3 and t4. Accordingly, the first node N1 may have a voltage at which a threshold voltage of the first transistor T1 is compensated for the data signal. Therefore, the data voltage Vdata may be written to the storage capacitor Cst.

Thereafter, an anode initialization operation of the light-emitting element LD may be performed in the period between t5 and t6. For example, during the period between t5 and t6, the second initialization signal GB has an activation level and the seventh transistor T7 may be turned on. Accordingly, the second initialization voltage VINT2 may be applied to the first electrode (an anode electrode) of the light-emitting element LD.

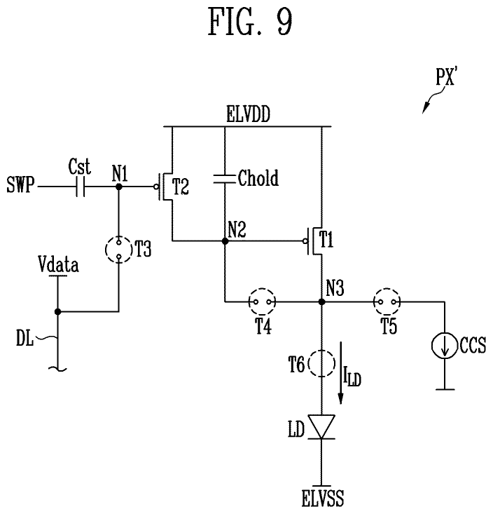

Thereafter, the emission period EP begins as the emission control signal EM changes to have the activation level at the time t7. For example, the fifth transistor T5 and the sixth transistor T6 may be turned on based on the emission control signal EM having the activation level in the emission period EP. Accordingly, the first power voltage ELVDD is applied to the first transistor T1 to generate a driving current I_{LD} (e.g., see FIG. 9), and the driving current I_{LD} may be applied to the light-emitting element LD. For example, the light-emitting element LD may emit light with luminance corresponding to the driving current I_{LD}.

A magnitude of the driving current I_{LD} may be determined based on the voltage of the control electrode of the first transistor T1. As described above, the voltage of the control electrode of the first transistor T1 is a voltage stored in the storage capacitor Cst, and may be the data voltage Vdata transmitted through the data line DL. As an example, the data voltage Vdata may be a voltage corresponding to a grayscale that is distinguished by a level from 0 to 255. The data voltage Vdata may also be a voltage divided into 256 levels. Therefore, as shown in FIG. 3, the driving current I_{LD} applied to the light-emitting element LD during the emission period EP may correspond to one of 256 current values from the current value I_{0G}, which corresponds to the minimum grayscale, to the current value 1255G, which corresponds to the maximum grayscale, according to the data voltage Vdata transmitted through the data line DL. A relatively large driving current I_{LD} may be applied to a light-emitting element of a pixel receiving the data voltage Vdata corresponding to the high grayscale, and a relatively small driving current I_{LD} may be applied to a light-emitting element of a pixel receiving the data voltage Vdata corresponding to a low grayscale.

As described above with respect to FIGS. 2 and 3, currents of different sizes may be applied to the light-emitting element LD in the pixel according to data values. The light-emitting element LD may generate light of different luminance according to data values.

However, depending on the characteristics of a light-emitting element, when the magnitude of the current applied to a light-emitting element varies, a wavelength of light generated by the light-emitting element may vary. As an example, when a light-emitting element is composed of an organic light-emitting diode (OLED), a wavelength generated by the OLED may change according to the density of current flowing through the OLED. When the density of current flowing through the OLED increases, the wavelength of light generated by the OLED may be shortened or lengthened.

Depending on a color of light generated by the OLED, the wavelength may change in different ways according to the change in current density. For example, when the current density of an OLED for generating blue light and an OLED for generating green light increases, the wavelength of the generated light may decrease, whereas when the current density of an OLED generating red light increases, the wavelength of the generated light may increase. In addition, when the same current density change occurs, the wavelength change width of green light may be relatively greater than that of blue light.

When the luminance of the light-emitting element LD is controlled by the magnitude of the current during the emission period EP, not only the intensity, but also the wavelength of light generated by an individual pixel, may change due to different currents being applied to the light-emitting element LD, which may cause a color of the image displayed by the display panel 100 to be distorted. Therefore, it is suitable to control the luminance of the light-emitting element LD during the emission period EP by a factor other than the magnitude of the current.

According to a pixel according to one or more other embodiments of the disclosure, a magnitude of a current applied to the light-emitting element LD included in each pixel is maintained the same during the emission period EP, but the time during which the light-emitting element LD generates light during the emission period EP is controlled based on the magnitude of the data voltage Vdata. Accordingly, a phenomenon in which the color of the image displayed by the display panel is distorted may be reduced or prevented.

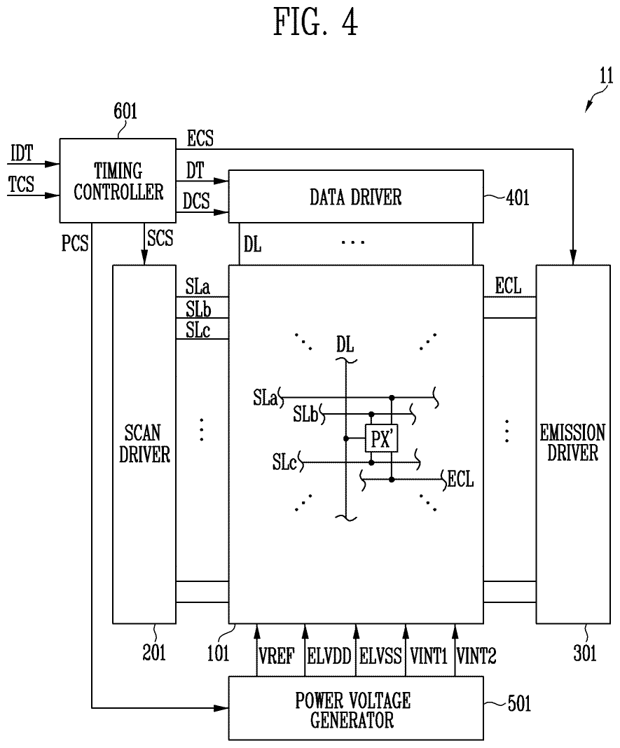

FIG. 4 is a block diagram illustrating a display device 11 according to one or more other embodiments of the disclosure.

Referring to FIG. 4, the display device 11 may include a display panel 101, a scan driver 201, an emission driver 301, a data driver 401, a power voltage generator 501, and a timing controller 601. The components shown in FIG. 4 (e.g., the display panel 101, the scan driver 201, the emission driver 301, the data driver 401, the power voltage generator 501, and/or the timing controller 601) may be substantially the same as or similar to the components shown in FIG. 1 (e.g., the display panel 100, the scan driver 200, the emission driver 300, the data driver 400, the power voltage generator 500, and/or the timing controller 600). Therefore, descriptions of the components shown in FIG. 4 that overlap with those in FIG. 1 will be omitted.

Referring to FIG. 4, the display panel 101 may include a plurality of pixels PX′ for displaying an image, and may display an image corresponding to the input image data IDT by the plurality of pixels PX′.

Each of the plurality of pixels PX′ may be electrically connected to a first scan line SLa, a second scan line SLb, a third scan line SLc, the emission control line ECL, and the data line DL. However, the above-described connection structure is provided as an example, and the number of scan lines or emission control lines connected to each pixel PX′ is not limited to FIG. 4.

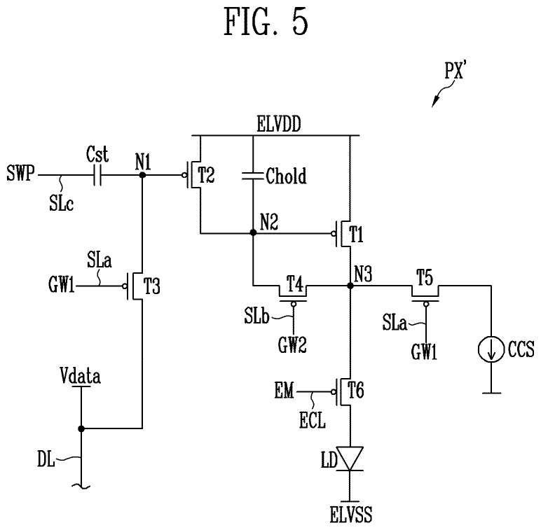

FIG. 5 is a schematic diagram of an equivalent circuit of the pixel PX′ illustrated in FIG. 4.

Referring to FIG. 5, the pixel PX′ may be connected to signal lines provided on a corresponding horizontal line and a corresponding vertical line. For example, the pixel PX′ may be connected to the first scan line SLa, the second scan line SLb, the third scan line SLc, and the emission control line ECL located on the corresponding horizontal line, and the data line DL located on the corresponding vertical line.

The pixel PX′ may include the first to sixth transistors T1 to T6, the storage capacitor Cst, a hold capacitor Chold, the light-emitting element LD, and a constant current source CCS. The pixel PX′ may be driven by driving signals and driving voltages. The driving signals may include a first scan signal GW1, a second scan signal GW2, a duty control signal SWP, the emission control signal EM, and a data signal (for example, the data voltage Vdata). In one or more embodiments, the driving voltages may include the reference voltage VREF, the first initialization voltage VINT1, and/or the second initialization voltage VINT2.

The first transistor T1 (the driving transistor) includes a control electrode connected to the second node N2, a first electrode for receiving the first power voltage ELVDD (for example, a high power voltage), and a second electrode connected to the third node N3. The second transistor T2 includes a control electrode connected to the first node N1, a first electrode for receiving the first power voltage ELVDD, and a second electrode connected to the second node N2. The third transistor T3 includes a control electrode for receiving the first scan signal GW1, a first electrode connected to the first node N1, and a second electrode for receiving the data voltage Vdata. The fourth transistor T4 includes a control electrode for receiving the second scan signal GW2, a first electrode connected to the second node N2, and a second electrode connected to the third node N3. The fifth transistor T5 includes a control electrode for receiving the first scan signal GW1, a first electrode connected to the third node N3, and a second electrode connected to the constant current source CCS. The sixth transistor T6 includes a control electrode for receiving the emission control signal EM, a first electrode connected to the third node N3, and a second electrode connected to the anode electrode of the light-emitting element LD.

The storage capacitor Cst includes a first electrode for receiving the duty control signal SWP, and a second electrode connected to the first node N1. The hold capacitor Chold includes a first electrode connected to the first power voltage ELVDD, and a second electrode connected to the second node N2. The light-emitting element LD includes a first electrode (an anode electrode) connected to the second electrode of the sixth transistor T6, and a second electrode (a cathode electrode) receiving the second power voltage ELVSS (for example, a low power voltage). The constant current source CCS is connected to the second electrode of the fifth transistor T5.

The data voltage Vdata may be transmitted through the data line DL, and the emission control signal EM may be transmitted through the emission control line ECL.

The first to sixth transistors T1, T2, T3, T4, T5, and T6 may be implemented as p-channel metal oxide semiconductor (PMOS) transistors. However, the disclosure is not limited thereto. For example, at least one of the first to sixth transistors T1, T2, T3, T4, T5, or T6 may be implemented as an n-channel metal oxide semiconductor (NMOS) transistor.

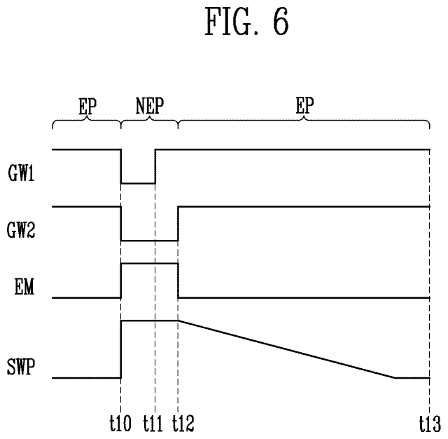

FIG. 6 is a timing diagram illustrating an example of an operation of the pixel PX′ illustrated in FIG. 5. Hereinafter, the operation of the pixel PX′ will be described with reference to FIGS. 5 and 6 together.

Referring to FIG. 6, an operation period of a pixel may be divided into the emission period EP and the non-emission period NEP, depending on whether the emission control signal EM is activated. In the emission period EP, the first scan signal GW1 and the second scan signal GW2 may have a deactivation level. In addition, the emission control signal EM may have an activation level in the emission period EP. In addition, the duty control signal SWP may have a low level in the emission period EP. Hereinafter, the operation of pixel in the non-emission period NEP will be first described.

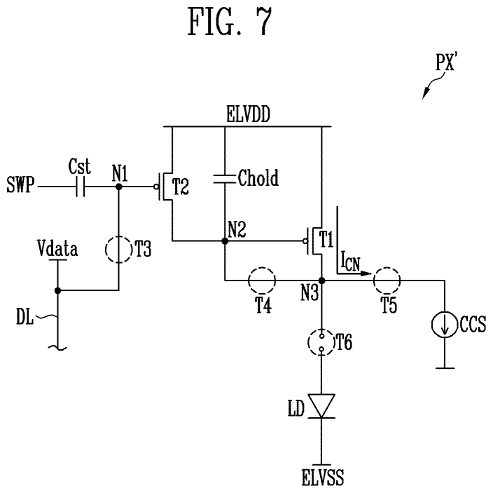

The non-emission period NEP begins when the emission control signal EM changes to have the deactivation level at time t10. In the non-emission period NEP, the duty control signal SWP may have a high level. At the time t10, the first scan signal GW1 and the second scan signal GW2 may change to have the activation level. Accordingly, the third to fifth transistors T3, T4, and T5 are turned on, and a write operation and a threshold voltage compensation operation are performed during the period between t10 and t11. The data voltage Vdata may be written to the first node N1 by the write operation of the period between t10 and t11. The voltage at which the threshold voltage of the first transistor T1 is compensated may be written to the second node N2 by the threshold voltage compensation operation during the period between t10 and t11. The operation of the pixel in FIG. 5 during the period between t10 and t11 will be described in more detail with reference to FIG. 7.

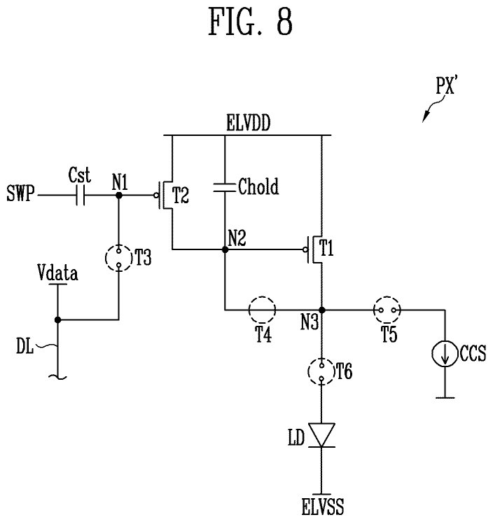

At the time t11, the first scan signal GW1 changes to have the deactivation level. Accordingly, the third and fifth transistors T3 and T5 are turned off. Therefore, the connection between the first node N1 and the data line DL is blocked, and the connection between the third node N3 and the constant current source CCS is blocked. The operation of the pixel in FIG. 5 during the period between t11 and t12 will be described in more detail with reference to FIG. 8.

The emission period EP begins as the emission control signal EM changes to have the activation level at the time t12. The second scan signal GW2 changes to have the deactivation level at the time t12. Accordingly, the fourth transistor T4 is turned off. In addition, at the time t12, the level of the duty control signal SWP starts to decrease over time.

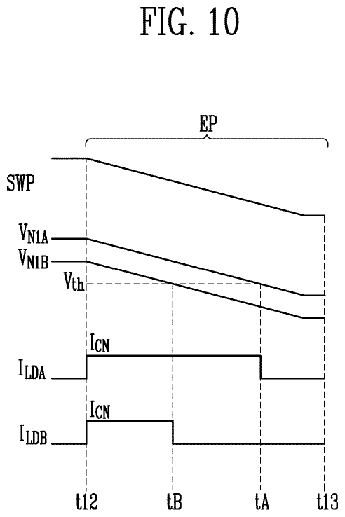

At the time t12, the second transistor T2 is in a turn-off state. At the time t12, the voltage of the first node N1 is the data voltage Vdata. As described above, when the data voltage Vdata represents data of 256 grayscales, the data voltage Vdata corresponding to a black grayscale, which is the lowest data, is greater than a turn-on voltage of the second transistor T2. Accordingly, the second transistor T2 is configured to be in the turn-off state at the time t12 regardless of the voltage of the first node N1. Thereafter, as the level of the duty control signal SWP decreases, the voltage of the first node N1 also decreases due to the coupling of the storage capacitor Cst. When the voltage of the first node N1 is lower than the turn-on voltage of the second transistor T2, the second transistor T2 is turned on. The time point at which the second transistor T2 is turned on may depend on the voltage of the first node N1 at the time t12. When the voltage of the first node N1 is relatively high at the time t12, the second transistor T2 is turned on relatively late, and when the voltage of the first node N1 is relatively low at the time t12, the second transistor T2 is turned on relative early. The turn-on time point of the second transistor T2 determines the turn-off time point of the first transistor T1, and as a result, the time point at which the driving current I_{LD} applied to the light-emitting element LD is interrupted is also determined. Therefore, when the voltage of the first node N1 is relatively high at the time t12, the light-emitting element LD generates light for a relatively long period of time, and when the voltage of first node N1 is relatively low at the time t12, the light-emitting element LD generates light for a relatively short period of time. Changes in voltage and driving current of the first node N1 during the emission period EP will be described in more detail with reference to FIG. 10.

As described above, according to the pixel according to one or more other embodiments of the disclosure, the magnitudes of the current applied to the light-emitting element LD included in each pixel is maintained the same during the emission period EP, but the time during which the light-emitting element LD generates light during the emission period EP is controlled based on the magnitude of the data voltage Vdata. Accordingly, a phenomenon in which the color of the image displayed by the display panel 101 is distorted may be reduced or prevented.

FIG. 7 is an equivalent circuit diagram illustrating the operation of the pixel illustrated in FIG. 5 during the period between t10 and t11 shown in FIG. 6. Hereinafter, descriptions will be made with reference to FIGS. 5, 6, and 7 together.

During the period between t10 and t11 in FIG. 6, the first scan signal GW1 and the second scan signal GW2 are changed to have the activation level. Accordingly, the third to fifth transistors T3, T4, and T5 are turned on. In FIG. 6, the turned-on third to fifth transistors T3, T4, and T5 are shown as short circuits. The emission control signal EM has a deactivation level during the period between t10 and t11, so the sixth transistor T6 is turned off. The turned-off sixth transistor T6 is shown as an open circuit in FIG. 7.

As shown in FIG. 7, as the third transistor T3 is turned on, the data voltage Vdata received through the data line DL is supplied to the first node N1. The data voltage Vdata is written to the first node N1 by the storage capacitor Cst connected to the first node N1.

As the fourth and fifth transistors T4 and T5 are turned on, the first transistor T1 is diode-connected, and a constant current I_{CN} supplied from the constant current source CCS flows through the first transistor T1. Therefore, the first transistor T1 operates in a saturation region, and the relationship between the voltage of the control electrode of the first transistor T1, that is, the second node N2, the threshold voltage of the first transistor T1, and the current flowing through the first transistor T1 is as shown in Equation 1 below.

$${I}_{CN} = \frac{1}{2} k \frac{W}{L} {( {V}_{GS} - {V}_{th} )}^{2}$$

In Equation 1 above, I_{CN} is a drain current flowing through the first transistor T1, which is the current supplied by the constant current source CCS as shown in FIG. 7. Also, Vas is a gate-source voltage of the first transistor T1. In Equation 1, k corresponds to a value of a process transconductance parameter of the first transistor T1, W corresponds to a width of a channel region of the first transistor T1, and L corresponds to a length of the channel region of the first transistor T1. For convenience of description, when

$$\frac{1}{2} k \frac{W}{L}$$

is represented as α, the gate-source voltage V_{GS} of the first transistor T1 can be expressed as Equation 2 below.

$${V}_{GS} = {V}_{th} + \sqrt{\frac{{I}_{CN}}{α}}$$

Therefore, a gate voltage of the first transistor T1, that is, the voltage of the second node N2, becomes the voltage at which the threshold voltage of the first transistor T1 is compensated. For example, the voltage at which the threshold voltage of the first transistor T1 is compensated can be written to the second node N2 by using the current of the constant current source CCS.

FIG. 8 is an equivalent circuit diagram illustrating the operation of the pixel illustrated in FIG. 5 during the period between t11 and t12 shown in FIG. 6. For example, the equivalent circuit during the period between t11 and t12 is illustrated, after the data voltage Vdata is written to the first node N1, and the voltage at which the threshold voltage of the first transistor T1 is compensated is written to the second node N2, and before the emission period EP starts. As shown in FIG. 8, during the period between t11 and t12, the third transistor T3, the fifth transistor T5, and the sixth transistor T6 may be turned off, and the fourth transistor T4 may be turned on.

FIG. 9 is an equivalent circuit diagram illustrating the operation of the pixel illustrated in FIG. 5 during the period between t12 and t13 shown in FIG. 6. For example, FIG. 9 is an equivalent circuit diagram illustrating the operation before the second transistor T2 is turned on during the periods of FIG. 6.

During the period between t12 and t13, the first scan signal GW1 and the second scan signal GW2 have a deactivation level. Accordingly, the third to fifth transistors T3, T4, and T5 are turned off. The emission control signal EM has an activation level during the period between t12 and t13, so the sixth transistor T6 is turned on.

As the sixth transistor T6 is turned on, the driving current I_{LD} is applied from the first transistor T1 to the light-emitting element LD. The magnitude of the driving current I_{LD} is determined by the voltage of the second node N2.

As described above with reference to FIG. 7, the voltage of the second node N2 is a voltage at which the threshold voltage of the first transistor T1 is compensated. Therefore, regardless of the threshold voltage of the first transistor T1, the driving currents I_{LD} of the plurality of pixels PX′ may be substantially the same. Before the second transistor T2 is turned on, the same driving current flows through the light-emitting elements LD included in the plurality of pixels PX′, so that the respective light-emitting elements LD may generate light of the same intensity. Thereafter, according to the voltage of the first node N1, the second transistors T2 of the respective pixels PX′ are turned on at different time points and the first transistors T1 are also turned off at different times. Therefore, the period during which the light-emitting elements LD included in the plurality of pixels PX′ generate light is determined according to the data voltage Vdata. Hereinafter, descriptions will be made with reference to FIG. 10.

FIG. 10 is a timing diagram illustrating changes in the voltage and the driving current of the first node N1 during the emission period EP. Referring to FIG. 10, the voltage change in the duty control signal SWP and first node voltages V_{N1A} and V_{N1B} and driving currents I_{LDA} and I_{LDB} of two pixels among the plurality of pixels are shown during the periods between t12 and t13 corresponding to the emission period EP among the periods of FIG. 6. For example, FIG. 10 shows changes in the voltage V_{N1A} of the first node N1 and the driving current I_{LDA} of a first pixel, and the voltage V_{N1B} of the first node N1 and the driving current I_{LDB} of a second pixel, among pixels located in the same row.

The voltage V_{N1A} of the first node N1 of the first pixel, and the voltage V_{N1B} of the first node N1 of the second pixel, may be set before the time t12. The voltage V_{N1A} of the first node N1 of the first pixel is greater than the voltage V_{N1B} of the first node N1 of the second pixel, so it can be seen that the data voltage Vdata corresponding to the first pixel is greater than the data voltage Vdata corresponding to the second pixel.

Because the emission period EP starts at the time t12, the driving current I_{LDA} starts to flow through the driving transistor T1 of the first pixel, and the driving current I_{LDB} starts to flow through the driving transistor T2 of the second pixel. As described above, because the voltage compensated for the threshold voltage of the first transistor T1 is written to the second node N2 in the non-emission period NEP, the magnitude of the driving current I_{LDA} of the first pixel, and the magnitude of the drive current I_{LDB} of the second pixel, may be substantially the same despite the difference in the threshold voltage of first transistor T1. In one or more embodiments, the magnitude of each of the driving currents I_{LDA} and I_{LDB} respectively flowing to the light-emitting elements LD of the first pixel and the second pixel immediately after the time t12 may be substantially the same as the magnitude of the constant current I_{CN} supplied from the constant current source CCS.

As the level of the duty control signal SWP decreases at the time t12, each of the voltage V_{N1A} of the first node of the first pixel and the voltage V_{N1B} of the first node of the second pixel starts to decrease due to the coupling of the storage capacitor Cst. When the voltages V_{N1A} and V_{N1B} of the first node of the first and second pixels become lower than a threshold voltage Vth of the second transistor T2, the second transistor T2 of each pixel is turned on. According to FIG. 10, a time tA when the second transistor T2 included in the first pixel is turned on is later than a time tB when the second transistor T2 included in the second pixel is turned on. For example, the second transistor T2 of the first pixel to which the relatively large data voltage Vdata is applied is turned on relatively late, and the second transistor T2 of the second pixel to which the relatively small data voltage Vdata is applied is turned on relatively early.

When the second transistor T2 is turned on, a relatively high-potential first power voltage ELVDD is applied to the control electrode of the first transistor T1, so that the first transistor T1 is turned off. When the first transistor T1 is turned off, the driving current I_{LD} supplied to the light-emitting element LD is also cut off. As shown in FIG. 10, the driving current I_{LDA} of the first pixel is cut off at the time tA when the second transistor T2 of the first pixel turns on, and the driving current I_{LDB} of the second pixel is cut off at the time tB when the second transistor T2 of the second pixel turns on.

The light-emitting element LD of the first pixel to which the relatively large data voltage Vdata is applied may generate light for a relatively long period of time, and the light-emitting element LD of the second pixel to which the comparatively small data voltage Vdata is applied may generate light for a relatively short period of time.

As described above, according to the pixel according to one or more other embodiments of the disclosure, the magnitude of the current applied to the light-emitting element LD included in each pixel is maintained the same during the emission period EP, but the time during which the light-emitting element LD generates light during the emission period EP is controlled based on the magnitude of the data voltage Vdata. Accordingly, a phenomenon in which the color of the image displayed by the display panel is distorted may be reduced or prevented.

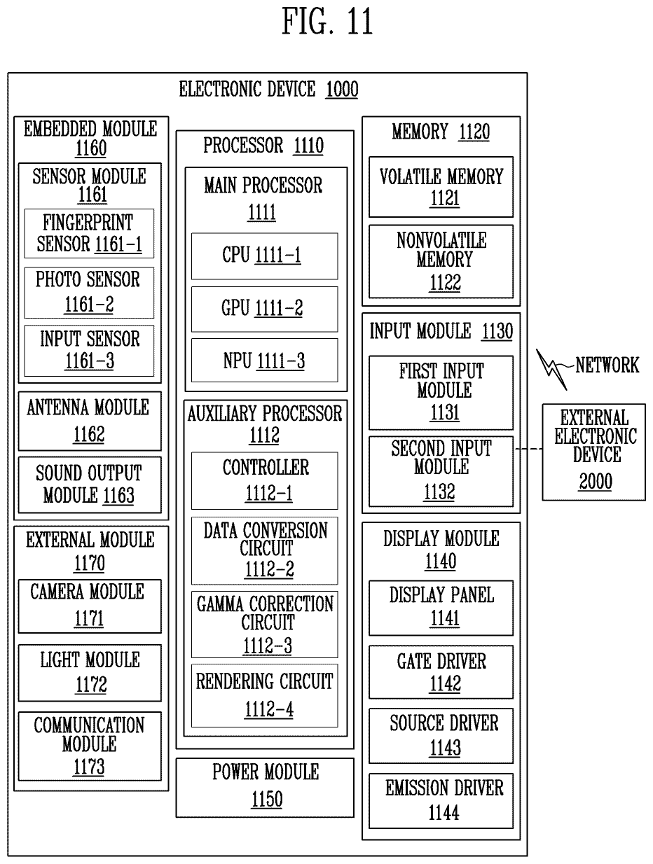

FIG. 11 is a diagram illustrating an electronic device 1000 according to one or more other embodiments of the disclosure.

Referring to FIG. 11, the electronic device according to one or more embodiments of the disclosure outputs various pieces of information through a display module 1140. The display module 1140 may correspond to at least a part of the display device 10 or 11 of FIG. 1 or FIG. 4. When a processor 1110 executes an application stored in a memory 1120, the display module 1140 provides application information to a user through a display panel 1141. The display panel 1141 may be a component corresponding to the display panel 100 or 101 of FIG. 1 or FIG. 4.

The processor 1110 obtains an external input through an input module 1130 or a sensor module 1161, and executes an application corresponding to the external input. For example, when the user selects a camera icon displayed on the display panel 1141, the processor 1110 obtains a user input through an input sensor 1161-3 and activates a camera module 1171. The processor 1110 transmits image data corresponding to a captured image acquired through the camera module 1171 to the display module 1140. The display module 1140 may display an image corresponding to the captured image through the display panel 1141.

As another example, when personal information authentication is executed in the display module 1140, a fingerprint sensor 1161-1 acquires input fingerprint information as input data. The processor 1110 compares the input data acquired through the fingerprint sensor 1161-1 with the authentication data stored in the memory 1120, and executes the application according to the comparison result. The display module 1140 may display information executed according to the logic of the application through the display panel 1141.

As another example, when a music streaming icon displayed on the display module 1140 is selected, the processor 1110 obtains the user input through the input sensor 1161-3, and activates a music streaming application stored in the memory 1120. When a music play command is input to the music streaming application, the processor 1110 activates a sound output module 1163 to provide sound information corresponding to the music play command to the user.

The operation of the electronic device 1000 has been briefly described above. Components of the electronic device 1000 will be described in detail below. Some of the components of the electronic device 1000 described below may be integrated and provided as one component, or one component may be divided and provided as two or more separate components.

The electronic device 1000 may communicate with an external electronic device 2000 through a network (for example, a near field communication network or a far field communication network). According to one or more embodiments, the electronic device 1000 may include the processor 1110, the memory 1120, the input module 1130, the display module 1140, a power module 1150, an embedded module 1160, and an external module 1170. According to one or more embodiments, at least one of the above-described components of the electronic device 1000 may be omitted, or one or more other components may be added. According to one or more embodiments, some of the above-described components (for example, the sensor module 1161, an antenna module 1162, or the sound output module 1163) may be integrated into another component (for example, the display module 1140).

The processor 1110 may execute software to control at least one other component (for example, a hardware or software component) of the electronic device 1000 which is connected to the processor 1110, and may perform various data processing or operations. According to one or more embodiments, as at least part of the data processing or operations, the processor 1110 may store commands or data received from other components (for example, the input module 1130, the sensor module 1161, or a communication module 1173) in a volatile memory 1121, process the commands or data stored in the volatile memory 1121, and store the result data in a non-volatile memory 1122.

The processor 1110 may include a main processor 1111 and an auxiliary processor 1112. The auxiliary processor 1112 may correspond to at least some components of the timing controller 600 or 601 of FIG. 1 or FIG. 4.

The main processor 1111 may include one or more of a central processing unit (CPU) 1111-1 or an application processor (AP). The main processor 1111 may further include one or more of a graphic processing unit (GPU) 1111-2, a communication processor (CP), or an image signal processor (ISP). The main processor 1111 may further include a neural processing unit (NPU) 1111-3. An NPU is a processor specialized in processing an artificial intelligence model, and the artificial intelligence model may be generated through machine learning. The artificial intelligence model may include a plurality of artificial neural network layers. An artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but is not limited to the foregoing examples. The artificial intelligence model may include a software structure in addition to the hardware structure, or in general. Two or more of the foregoing processing units and the processor may be implemented in one integrated component (for example, a single chip), or each may be implemented in an independent component (for example, a plurality of chips).

The auxiliary processor 1112 may include a controller 1112-1. The controller 1112-1 may include an interface conversion circuit and a timing control circuit. The controller 1112-1 receives an image signal from the main processor 1111, converts a data format of the image signal to meet an interface specification of the display module 1140, and outputs image data.

The controller 1112-1 may output various control signals suitable for driving the display module 1140.

The auxiliary processor 1112 may further include a data conversion circuit 1112-2, a gamma correction circuit 1112-3, a rendering circuit 1112-4, or the like. The data conversion circuit 1112-2 may receive the image data from the controller 1112-1, and compensate for the image data so that an image is displayed at desired luminance according to the characteristics of the electronic device 1000 or the user's settings, or convert the image data to reduce power consumption or compensate for afterimages.

The gamma correction circuit 1112-3 may convert image data, a gamma reference voltage, or the like so that an image displayed on the electronic device 1000 has a desired gamma characteristic. The rendering circuit 1112-4 may receive the image data from the controller 1112-1 and render the image data in consideration of the pixel arrangement in the display panel 1141 applied to the electronic device 1000. At least one of the data conversion circuit 1112-2, the gamma correction circuit 1112-3, or the rendering circuit 1112-4 may be integrated into another component (for example, the main processor 1111 or the controller 1112-1). At least one of the data conversion circuit 1112-2, the gamma correction circuit 1112-3, and the rendering circuit 1112-4 may be integrated into a source driver 1143 to be described below.

The memory 1120 may store various data used by at least one component of the electronic device 1000 (for example, the processor 1110 or the sensor module 1161) and input data or output data for commands related to the various data. The memory 1120 may include one or more of a volatile memory 1121 or a non-volatile memory 1122.

The input module 1130 may receive commands or data to be used for components of the electronic device 1000 (for example, the processor 1110, the sensor module 1161, or the sound output module 1163) from outside the electronic device 1000, such as the user or the external electronic device 2000.

The input module 1130 may include a first input module 1131 to which the user inputs a command or data, and a second input module 1132 to which the external electronic device 2000 inputs a command or data. The first input module 1131 may include a microphone, mouse, keyboard, key (for example, button) or pen (for example, passive pen or active pen). The second input module 1132 may support a specified protocol which may be connected to the external electronic device 2000 by wire or wirelessly. According to one or more embodiments, the second input module 1132 may include a high definition multimedia interface (HDMI), a universal serial bus (USB) interface, a Secure Digital (SD) card interface, or an audio interface. The second input module 1132 may include a connector which can be physically connected to the external electronic device 2000, for example, an HDMI connector, a USB connector, an SD card connector, or an audio connector (for example, a headphone connector).

The display module 1140 provides information to the user visually. The display module 1140 may include the display panel 1141, a gate driver 1142, the source driver 1143, and an emission driver 1144. The gate driver 1142 may correspond to at least a portion of the scan driver 200 or 201 shown in FIG. 1 or FIG. 4. The source driver 1143 may correspond to at least a portion of the data driver 400 or 401 shown in FIG. 1 or FIG. 4. The emission driver 1144 may correspond to at least a portion of the emission driver 300 and 301 shown in FIG. 1 or FIG. 4. The display module 1140 may further include a window, a chassis, and a bracket for protecting the display panel 1141.

The display panel 1141 (or a display) may include a liquid crystal display panel, an organic light-emitting display panel, or an inorganic light-emitting display panel. A type of the display panel 1141 is not particularly limited. The display panel 1141 may be of a rigid type or of a flexible type, such as a rollable type or a foldable type. The display module 1140 may further include a supporter, a bracket, a heat dissipation layer, or the like supporting the display panel 1141.

The gate driver 1142 may be mounted on the display panel 1141 as a driving chip. In addition, the gate driver 1142 may be integrated into the display panel 1141. For example, the gate driver 1142 may include an Amorphous Silicon TFT Gate driver circuit (ASG), a Low-Temperature Polycrystalline Silicon (LTPS) TFT gate driver circuit, or an (Oxide Semiconductor TFT Gate driver circuit (OSG) embedded in the display panel 1141. The gate driver 1142 receives a first control signal CS1 or a second control signal CS2 from the controller 1112-1, and outputs scan signals to the display panel 1141 in response to the first control signal CS1 or the second control signal CS2.

The emission driver 1144 may be mounted on the display panel 1141 as a driving chip. In addition, the emission driver 1144 may be integrated into the display panel 1141, similar to the gate driver 1142. The emission driver 1144 outputs an emission control signal to the display panel 1141 in response to the first control signal CS1 and the second control signal CS2 received from the controller 1112-1. The emission driver 1144 may be formed separately from the gate driver 1142, or may be integrated into the gate driver 1142. Additionally, the emission driver 1144 may generate the emission control signal in response to an emission start signal supplied from a start signal controller.

The source driver 1143 receives the first control signal CS1 or the second control signal CS2 from the controller 1112-1, converts the image data into an analog voltage (for example, a data signal) in response to the first control signal CS1 or the second control signal CS2, and outputs data signals to the display panel 1141.

The source driver 1143 may be integrated into another component (for example, the controller 1112-1). Functions of the interface conversion circuit and the timing control circuit of the controller 1112-1 described above may be integrated into the source driver 1143.

The display module 1140 may further include a voltage generation circuit. The voltage generation circuit may output various voltages required for driving the display panel 1141. In one or more embodiments, the display panel 1141 may include a plurality of pixel columns each including a plurality of pixels.

In one or more embodiments, the source driver 1143 may convert data (for example, output data) corresponding to red (R), green (G), and blue (B) colors included in the image data received from the processor 1110 into a red data signal (or a data voltage), a green data signal, and a blue data signal, and provide the converted data to the plurality of pixel columns included in the display panel 1141 during one horizontal period.

The power module 1150 supplies power to the components of the electronic device 1000. The power module 1150 may include a battery that charges a power voltage. The battery may include a non-rechargeable primary battery, a rechargeable secondary battery, or a fuel cell. The power module 1150 may include a power management integrated circuit (PMIC). The PMIC supplies optimized power to each of the modules described above and modules to be described below. The power module 1150 may include a wireless power transmitting/receiving member electrically connected to the battery. The wireless power transmitting/receiving member may include a plurality of antenna radiators in the form of coils.

The electronic device 1000 may further include the embedded module 1160 and the external module 1170. The embedded module 1160 may include the sensor module 1161, the antenna module 1162, and the sound output module 1163. The external module 1170 may include the camera module 1171, a light module 1172, and the communication module 1173.

The sensor module 1161 may sense an input by the user's body or an input by a pen of the first input module 1131, and generate an electrical signal or data value corresponding to the input. In addition, the sensor module 1161 may sense an external environment (for example, illuminance, temperature, or the like), and may generate an electrical signal or data value corresponding to the external environment.

The sensor module 1161 may include at least one of the fingerprint sensor 1161-1, a photo sensor 1161-2, or the input sensor 1161-3. The fingerprint sensor 1161-1 may generate a data value corresponding to the user's fingerprint. The fingerprint sensor 1161-1 may include either an optical type or a capacitive type fingerprint sensor.

The photo sensor 1161-2 (or an illuminance sensor) may sense external illuminance and provide an electrical signal or data value corresponding to the sensed illuminance to the auxiliary processor 1112 (or the processor 1110). Additionally, the photo sensor 1161-2 may provide a photo sensing signal PS to the controller 1112-1 at the time when the illuminance is sensed. The controller 1112-1 supplied with the photo sensing signal PS may control the number of off periods included in the emission start signal. For example, when the photo sensing signal PS is supplied, the controller 1112-1 may control the emission start signal so that a smaller number of off periods of the emission start signal are included in one frame period of a second driving frequency.

The input sensor 1161-3 may generate a data value corresponding to coordinate information of the input by the user's body or the input by the pen. The input sensor 1161-3 generates the amount of change in capacitance due to the input as the data value. The input sensor 1161-3 may sense an input by a passive pen or transmit and receive data to and from an active pen.

The input sensor 1161-3 may measure biosignals such as blood pressure, moisture, or body fat. For example, when the user contacts a part of the body with a sensor layer or a sensing panel and does not move for a certain period of time, based on a change in the electric field caused by the part of the body, the input sensor 1161-3 may sense a biosignal and output information desired by the user to the display module 1140.

The sensor module 1161 may further include a digitizer. The digitizer may generate a data value corresponding to the coordinate information of the input by the pen. The digitizer generates the amount of electromagnetic change by the input as a data value. The digitizer may sense the input by the passive pen or transmit and receive data to and from the active pen.

At least one of the fingerprint sensor 1161-1, the photo sensor 1161-2, or the input sensor 1161-3 may be implemented as a sensor layer formed on the display panel 1141 through a continuous process.

Two or more of the fingerprint sensor 1161-1, the photo sensor 1161-2, or the input sensor 1161-3 may be formed to be integrated into one sensing panel through the same process. When integrated into one sensing panel, the sensing panel may be located between the display panel 1141 and a window located above the display panel 1141. According to one or more embodiments, the sensing panel may be located on the window, and the position of the sensing panel is not particularly limited.

At least one of the fingerprint sensor 1161-1, the photo sensor 1161-2, or the input sensor 1161-3 may be embedded in the display panel 1141. That is, at least one of the fingerprint sensor 1161-1, the photo sensor 1161-2, or the input sensor 1161-3 may be simultaneously formed through a process of forming elements (for example, a light-emitting element, a transistor, or the like) included in the display panel 1141.

In addition, the sensor module 1161 may generate an electrical signal or data value corresponding to an internal state or an external state of the electronic device 1000. The sensor module 1161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, or a humidity sensor.

The antenna module 1162 may include one or more antennas for transmitting or receiving signals or power externally. According to one or more embodiments, the communication module 1173 may transmit a signal to or receive a signal from the external electronic device 2000 through an antenna suitable for a communication method. An antenna pattern of the antenna module 1162 may be integrated into one component (for example, the display panel 1141) of the display module 1140 or the input sensor 1161-3.

The sound output module 1163 is a device for outputting a sound signal to the outside of the electronic device 1000, and may include, for example, a speaker used for general purposes such as multimedia playback or recording playback, and a receiver used exclusively for receiving phone. According to one or more embodiments, the receiver may be formed integrally with or separately from the speaker. A sound output pattern of the sound output module 1163 may be integrated into the display module 1140.

The camera module 1171 may capture still images and film videos. According to one or more embodiments, the camera module 1171 may include one or more lenses, image sensors, or image signal processors. The camera module 1171 may further include an infrared camera capable of measuring the presence or absence of the user, the position of the user, a gaze of the user, and the like.

The light module 1172 may provide light. The light module 1172 may include a light-emitting diode or a xenon lamp. The light module 1172 may operate in conjunction with the camera module 1171 or may operate independently.

The communication module 1173 may support establishment of a wired or wireless communication channel between the electronic device 1000 and the external electronic device 2000, and communication through the established communication channel. The communication module 1173 may include one or both of a wireless communication module such as a cellular communication module, a near field communication module, or a global navigation satellite system (GNSS) communication module, and a wired communication module such as a local area network (LAN) communication module or a power line communication module. The communication module 1173 may communicate with the external electronic device 2000 via a local area network such as Bluetooth® (Bluetooth® being a registered trademark of Bluetooth Sig, Inc., Kirkland, WA), Wi-Fi Direct™ (Wi-Fi Direct™ being a registered trademark of the non-profit Wi-Fi Alliance), or infrared data association (IrDA), or a long distance communication network such as a cellular network, the Internet, or a computer network (for example, a LAN or a wide area network (WAN)). The various types of communication modules 1173 described above may be implemented as one chip or may be implemented as separate chips.

The input module 1130, the sensor module 1161, the camera module 1171, and the like may be utilized to control the operation of the display module 1140 in conjunction with the processor 1110.

The processor 1110 outputs a command or data to the display module 1140, the sound output module 1163, the camera module 1171, or the light module 1172 based on input data received from the input module 1130. For example, the processor 1110 may generate image data in response to input data applied through a mouse, an active pen, or the like and output the image data to the display module 1140, or may generate command data in response to the input data and output the command data to the camera module 1171 or the light module 1172. When input data is not received from the input module 1130 for a certain period of time, the processor 1110 may switch an operation mode of the electronic device 1000 to a low power mode or a sleep mode to reduce power consumed by the electronic device 1000.

The processor 1110 outputs a command or data to the display module 1140, the sound output module 1163, the camera module 1171, or the light module 1172 based on sensing data received from the sensor module 1161. For example, the processor 1110 may compare the authentication data authorized by the fingerprint sensor 1161-1 with the authentication data stored in the memory 1120, and then may execute the application according to the comparison result. The processor 1110 may execute a command or output corresponding image data to the display module 1140 based on the sensing data sensed by the input sensor 1161-3. The processor 1110 may control the luminance of the display panel 1141 in response to the illuminance sensed from the photo sensor 1161-2. When the sensor module 1161 includes a temperature sensor, the processor 1110 may receive temperature data for the measured temperature from the sensor module 1161, and further perform luminance correction or the like on the image data based on the temperature data.

The processor 1110 may receive measurement data on the presence or absence of the user, the position of the user, the gaze of the user, and the like from the camera module 1171. The processor 1110 may further correct luminance of the image data based on the measurement data. For example, the processor 1110 that determines the presence or absence of the user through the input from the camera module 1171 may output the image data whose luminance is corrected to the display module 1140 through the data conversion circuit 1112-2 or the gamma correction circuit 1112-3.

Some of the above components may be connected to each other through a communication method between peripheral devices, for example, a bus, a general purpose input/output (GPIO), a serial peripheral interface (SPI), a mobile industry processor interface (MIPI), or an ultra path interconnect (UPI) link to exchange signals (for example, commands or data) with each other. The processor 1110 may communicate with the display module 1140 through a mutually agreed interface, for example, one of the above-described communication methods may be used, but communication methods are not limited thereto.

The electronic device 1000 according to various embodiments disclosed in this document may be a device of various types. Examples of the electronic device 1000 may include at least one of a portable communication device (for example, a smartphone), a computer device, a portable multimedia device, a portable medical device, a camera, a wearable device, or a home appliance. The electronic device 1000 according to one or more embodiments of this document is not limited to the above-described devices.

The disclosure have been described with reference to embodiments, but it will be understood that those skilled in the art can make various modifications and changes to the disclosure without departing from the spirit and scope of the disclosure as set forth in the claims.

In a pixel, a display device, and an electronic device including the same according to embodiments of the disclosure, a color shift phenomenon of a light-emitting element may be reduced.

However, the aspects of the disclosure are not limited to the aspects described above, and may be variously extended without departing from the spirit and scope of the disclosure.

What is claimed is:

1. A pixel comprising:
a second transistor having a control electrode connected to a first node, a first electrode for receiving a first power voltage, and a second electrode connected to a second node;
a first transistor having a gate electrode connected to the second node, a first electrode for receiving the first power voltage, and a second electrode connected to a third node; and
a light-emitting element configured to be supplied with a driving current from the first transistor,
wherein a turn-on time point of the second transistor is determined by a data voltage, and
wherein the driving current supplied to the light-emitting element is configured to be interrupted as the second transistor is turned on.

2. The pixel according to claim 1, further comprising:
a third transistor having a control electrode connected to a first scan line, a first electrode connected to the first node, and a second electrode connected to a data line for supplying the data voltage; and
a first capacitor having a first electrode connected to a third scan line, and a second electrode connected to the first node,
wherein the data voltage is configured to be written to the first node by the first capacitor as the third transistor is turned on.

3. The pixel according to claim 2, wherein the third transistor is configured to be turned off during an emission period,
wherein a duty control signal decreasing over time during the emission period is configured to be supplied from the third scan line, and
wherein a voltage of the first node is configured to decrease over time by the first capacitor in response to the decreasing duty control signal.

4. The pixel according to claim 2, further comprising:
a current source for supplying a constant current;
a second capacitor having a first electrode for receiving the first power voltage, and a second electrode connected to the second node;
a fourth transistor having a control electrode connected to a second scan line, a first electrode connected to the second node, and a second electrode connected to the third node; and
a fifth transistor having a control electrode connected to the first scan line, a first electrode connected to the third node, and a second electrode connected to the current source.

5. The pixel according to claim 4, wherein the fourth transistor and the fifth transistor are configured to be turned on, and the gate electrode and the second electrode of the first transistor are configured to be electrically connected to each other, during a first period in a non-emission period.

6. The pixel according to claim 5, wherein the constant current is configured to be supplied to a drain of the first transistor, and
wherein a voltage at which a threshold voltage of the first transistor is compensated is configured to be written to the second node by the second capacitor.

7. The pixel according to claim 5, wherein the fourth transistor and the fifth transistor are configured to be turned off during an emission period.

8. The pixel according to claim 4, further comprising a sixth transistor having a control electrode connected to an emission control line, a first electrode connected to the third node, and a second electrode connected to an anode electrode of the light-emitting element.

9. The pixel according to claim 8, wherein the sixth transistor is configured to be turned off during a non-emission period, and is configured to be turned on during an emission period.

10. The pixel according to claim 8, wherein the first transistor is configured to be turned off at the turn-on time point of the second transistor during an emission period, and
wherein the driving current to the light-emitting element is configured to be interrupted as the first transistor is turned off.

11. A display device comprising:
a display panel comprising pixels;
a scan driver connected to the display panel through scan lines;
a data driver connected to the display panel through data lines; and
a timing controller for receiving image data, and for controlling driving of the scan driver and the data driver to display an image corresponding to the image data,
wherein the pixels comprise:
a second transistor having a control electrode connected to a first node, a first electrode for receiving a first power voltage, and a second electrode connected to a second node;
a first transistor having a gate electrode connected to the second node, a first electrode for receiving the first power voltage, and a second electrode connected to a third node; and
a light-emitting element configured to be supplied with a driving current from the first transistor,
wherein a turn-on time point of the second transistor is configured to be determined by a data voltage supplied through a data line among the data lines, and
wherein the driving current to the light-emitting element is configured to be interrupted as the second transistor is turned on.

12. The display device according to claim 11, wherein the scan lines comprise a first scan line, a second scan line, and a third scan line,
wherein the pixels further comprise:
a third transistor having a control electrode connected to the first scan line, a first electrode connected to the first node, and a second electrode connected to the data line; and
a first capacitor having a first electrode connected to the third scan line, and a second electrode connected to the first node, and
wherein the data voltage is configured to be written to the first node by the first capacitor as the third transistor is turned on.

13. The display device according to claim 12, wherein the third transistor is configured to be turned off during an emission period,
wherein a duty control signal decreasing over time during the emission period is configured to be supplied from the third scan line, and
wherein a voltage of the first node is configured to decrease over time by the first capacitor in response to the decreasing duty control signal.

14. The display device according to claim 12, wherein the pixels further comprise:
a current source for supplying a constant current;
a second capacitor having a first electrode for receiving the first power voltage, and a second electrode connected to the second node;
a fourth transistor having a control electrode connected to the second scan line, a first electrode connected to the second node, and a second electrode connected to the third node; and
a fifth transistor having a control electrode connected to the first scan line, a first electrode connected to the third node, and a second electrode connected to the current source.

15. The display device according to claim 14, wherein the fourth transistor and the fifth transistor are configured to be turned on, and the gate electrode and the second electrode of the first transistor are configured to be electrically connected to each other, during a first period in a non-emission period.

16. The display device according to claim 15, wherein the constant current is configured to be supplied to a drain of the first transistor, and
wherein a voltage at which a threshold voltage of the first transistor is compensated is configured to be written to the second node by the second capacitor.

17. The display device according to claim 15, wherein the fourth transistor and the fifth transistor are configured to be turned off during an emission period.

18. The display device according to claim 14, wherein the pixels further comprise a sixth transistor having a control electrode connected to an emission control line, a first electrode connected to the third node, and a second electrode connected to an anode electrode of the light-emitting element.

19. The display device according to claim 18, wherein the sixth transistor is turned off during a non-emission period and the sixth transistor is turned on during an emission period.

20. An electronic device comprising:
a processor for providing input image data; and
a display device for displaying an image based on the input image data,
wherein the display device comprises:
a display panel comprising pixels;
a scan driver connected to the display panel through scan lines;
a data driver connected to the display panel through data lines; and
a timing controller for receiving image data and for controlling driving of the scan driver and the data driver to display an image corresponding to the image data,
wherein the pixels comprise:
a second transistor having a control electrode connected to a first node, a first electrode for receiving a first power voltage, and a second electrode connected to a second node;
a first transistor having a gate electrode connected to the second node, a first electrode for receiving the first power voltage, and a second electrode connected to a third node; and
a light-emitting element supplied with a driving current from the first transistor,
wherein a turn-on time point of the second transistor is determined by a data voltage supplied through a data line among the data lines, and
wherein the driving current to the light-emitting element is configured to be interrupted as the second transistor is turned on.
